(19) United States
(12) Patent Application Publication
(10) Pub. No.: US 2005/0055636 A1
(43) Pub. Date: Mar. 10, 2005

(54) Dynamic editing of multimedia content for real-time applications

(76) Inventor: Roger Graves, Santa Rosa, CA (US)

Correspondence Address: PILLSBURY WINTHROP LLP, 2475 Hanover Street, Palo Alto, CA, 94304-1115, US

(21) Appl. No.: 10/898,087

(22) Filed: Jul. 21, 2004

Related U.S. Application Data
(60) Provisional application No. 60/489,076, filed on Jul. 21, 2003.

(51) Int. Cl. G06F 17/00

(52) U.S. Cl. 715/526

(57) ABSTRACT

A method is provided for automatically preparing digital image data received by a computer for insertion into particular applications, such as a web site, where predetermined image parameters are desired. The computer is programmed to automatically determine if the received image conforms to a desired height and width, and if it does not, the computer automatically adjusts the image data to bring the dimensions into conformance. The computer also automatically checks the data format, and if it does not conform to a desired format, the data is converted. The computer also automatically checks the image resolution, and if it does not conform to a desired value, the computer adjusts the resolution accordingly.

### BACKGROUND OF THE INVENTION

1. Field of the Invention

The present invention generally relates to methods of preparing and loading multimedia content into a real-time application, and more particularly to methods that fully automate the process of transferring digital image data into an Internet web application after first automatically processing the image to desired parameters.

2. Description of the Prior Art

Within the past decade, publishing data to the Internet has become a common means for communicating information. This information can include text-based data, as well as multimedia information such as sound bites, video footage or still images. As is known, publishing information to the Internet requires expertise in many computer-related fields. The data-page format and textual information must be coded in an Internet-friendly language for ease of viewing via the World Wide Web (WWW), for example Hyper Text Markup Language (HTML) or Extensible Markup Language (XML). Further, video and audio clips must be edited for content, size and proper format. Additionally, still images must be digitized, re-sized, re-shaped, properly formatted and saved to a desired resolution.

Typically, the pre-processing of still images for use on the Internet is performed manually within a stand-alone digital image processing program. A user first obtains a digitized image of random size, shape, format and resolution. This digitized image can be, for example, taken directly from a digital camera or captured using a digital scanner on a standard photograph. The user then manually re-shapes and re-sizes the digital image using the stand-alone digital image processing program. This re-shaping and re-sizing can be a time-consuming, iterative process. Once the user has made the digital image the proper shape and size, the user saves the image to a file using the desired format. If the new file size of the manually-processed digital image is too large, the user can then re-save the image at a new resolution to yet another file. Only after the image is saved in the desired format, at the required size, shape and resolution, can the user load the image file for use in an application on the Internet.

The manual pre-processing of still images for use on the Internet is time consuming, expensive and user-limiting. It is time consuming by requiring the user to import the digital image into a processing program and to manually manipulate the image using the packaged commands of the processing program. It is expensive due to the extra time involved for the user to manually manipulate the digital image and the extra cost of the processing program. It is user-limiting in that-not every person who desires to publish images to the Internet will take the time to learn the processing program or incur the added expense of buying the processing program.

Therefore, what is needed is a way to streamline the image upload process so that any user, without specific knowledge of image manipulation using a digital image processing program, can select any digital image for use in any application on the Internet and have that image automatically uploaded at the desired characteristics, including, but not limited to: size, shape, format and resolution.

### SUMMARY OF THE INVENTION

In one embodiment of the present invention, a method is provided for automatically preparing digital image data received by a computer for insertion in a particular target application, such as: a document on the Internet, a database on an Intranet, a presentation on a Local Area Network, or a sales website on a client-accessible Extranet. The computer is programmed to automatically determine if the received photo conforms to a predefined size and shape, and if it does not, the computer automatically adjusts the image file to bring the dimensions into conformance. The computer also automatically checks the image file format and converts it to a predefined format if required. The computer then automatically checks the image file resolution. If it does not conform to a predefined resolution, the computer automatically adjusts the resolution accordingly. The computer completes the automatic process by inserting the final image into the target application.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 illustrates a flow chart of the process according to an embodiment of the present invention;

FIG. 2 illustrates a detailed flow chart of the process of block 155 in FIG. 1 according to an embodiment of the present invention;

FIG. 3 illustrates a flow chart describing the scaling/multiplying process according to an embodiment of the present invention;

FIG. 4 illustrates a flow chart describing the cropping process according to an embodiment of the present invention; and

FIG. 5 illustrates a flow chart describing an alternative cropping process according to an embodiment of the present invention.

### DETAILED DESCRIPTION OF THE INVENTION

The present invention will now be described in detail with reference to the drawings, which are provided as illustrative examples of the invention so as to enable those skilled in the art to practice the invention. Notably, the figures and examples below are not meant to limit the scope of the present invention. Moreover, where certain elements of the present invention can be partially or fully implemented using known components, only those portions of such known components that are necessary for an understanding of the present invention will be described, and detailed descriptions of the other portions of such known components will be omitted so as not to obscure the invention. Further, the present invention encompasses present and future known equivalents to the known components referred to herein by way of illustration.

The present invention provides a method of automatically preparing digital images for placement in a desired website or other application/destination. The digital image can be received from any source and be any random size, shape, format and resolution. For example, the digital image could originate from: a digital camera or digital video unit as a Tagged Image File Format (TIFF) image at a very high resolution; a digitally scanned version of a film camera negative or print as a Joint Photographic Experts Group (JPEG) image at low resolution; or a computer digital art program as a Graphics Interchange Format (GIF) image at medium resolution. Additionally, the digital image can be at any aspect ratio. For example, the digital image could come from any one of the three user-selectable Advanced Photo System formats: the “C” format or 2:3 ratio; the “H” format or 9:16 ratio; or the “P” format or 1:3 ratio. Likewise, the digital image could come from a digital still or video camera source with a 4:3 ratio or a series of these digicam images stitched together. Finally, the digital image could be originally created using any computer graphics software and at any aspect ratio and size.

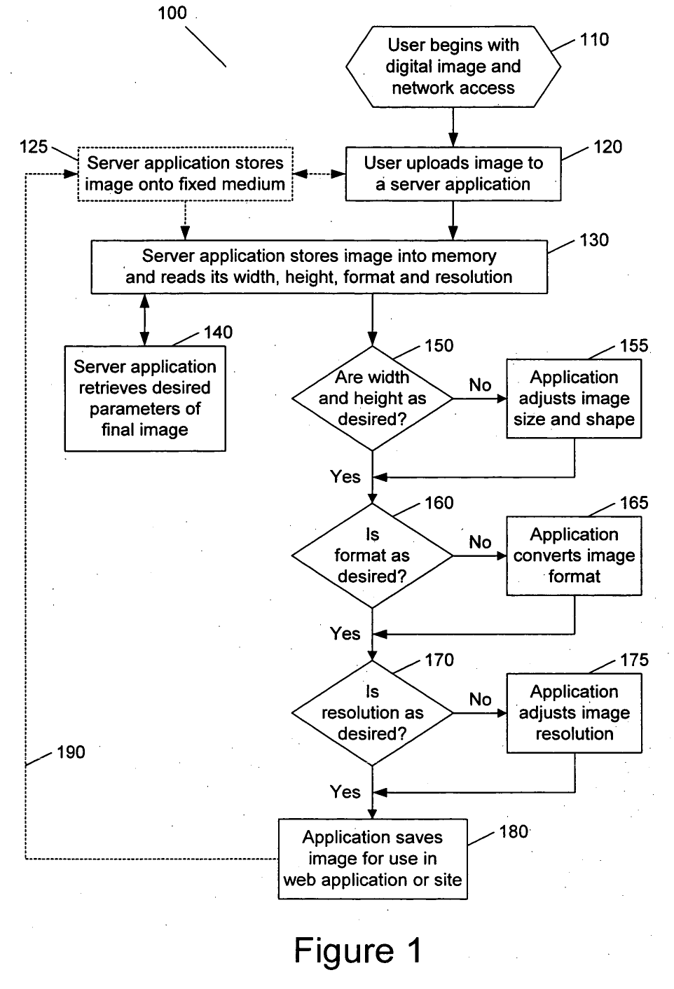

FIG. 1 illustrates an embodiment of the present invention (method 100). Various modifications of this method will be apparent to those skilled in the art and these are also included in the spirit of the present invention. For instance, the separate functional blocks depicted in FIG. 1 might be combined into one, or a single functional block might be split into many sub-functional bocks. The following description is focused on loading digital photo data to a website or web application. Other target destinations/applications are included in the spirit of the present invention, for example: presentation or word processing applications, creative drawing applications; engineering or architectural design applications; video production applications; and sales or marketing applications. The target destination of a website or web application is given by example.

As shown in FIG. 1, a user begins the process of the present invention with any random digital image file that the user desires to load into a target location, such as, for example, onto a website or web application that is accessible via the Internet (block 110). The Internet access can be by any current or future means available, for example: by computer via modem; by Personal Digital Assistant (PDA) via a WiFi HotSpot, or by digital camera capable cellular phone via a cellular network. The user then uploads the digital image file to a server application on a web server via the Internet access (block 120). In this embodiment, the server application and the ultimate destination website are located on the same web server. However, it will be apparent to those skilled in the art that collocation of these aspects is not a necessary element of the present invention; that is, these aspects of the present invention could be accomplished for remotely located web applications and websites that do not come off of the web server.

Optionally, the server application can store the uploaded digital image file onto a fixed medium (block 125). The fixed medium can be, for example, any type of non-volatile memory (e.g., hard drive, tape drive, optical drive, etc.). By saving the originally uploaded digital image file in this manner, the server application program can recall the image at a later date/time for another adjustment according to the present invention.

Next, the server application stores the digital image file into a memory and reads the image width, height, format and resolution information (block 130). Alternately, for images previously uploaded and saved onto a fixed medium, the server application program might retrieve a digital image file from fixed storage. Note that throughout this disclosure, the parameters width and height are used generically to designate a desired size and shape of the finally altered digital image. As should be evident to those skilled in the art, other parameters could easily be used as well, such as: aspect ratio with either height or width, or aspect ratio with a desired percentage of total viewing area. The server application then retrieves the desired target image parameters for the digital image file for placement of the digital image file on the desired web location (block 140). These parameters can come from any number of sources. Source examples include: a database accessible by the web server, a text file stored on the web server, an XML file queried from a remote server, a remote application, remote user input, or information imbedded within the destination web application or website. Further examples include the following.
i) A remote application (written in any language) connected to the Internet has, embedded within it, the parameters it requires for accepting dynamic images over the web and using them. This remote application could be anything, such as, a game, a chat program, a dating program, or a business sales page. The server application of the present invention retrieves the parameters from the remote application. The server application then uploads an original copy of the digital image (i.e., in its preexisting condition), alters the image according to aspects of the present invention the image and based on the uploaded parameters, then sends the altered digital image to the remote application.
ii) A user uploads a digital image to the server application using a browser. In the server application form they used to upload the graphic, the user also manually enters the desired width, height, resolution, and format.
iii) A user uploads an image to the server application using a browser, where the image is ultimately targeted for placement and use with a form (i.e., a form used for filling in registration information). Within the form is embedded the width, height, resolution, and format.
iv) A user uploads an image to the server application using a browser. The server application queries a database, or reads a text file residing on the server, for the parameters.

After retrieving the desired target image parameters for the digital image file, the server application program is ready to complete the automatic adjustments to the digital image file.

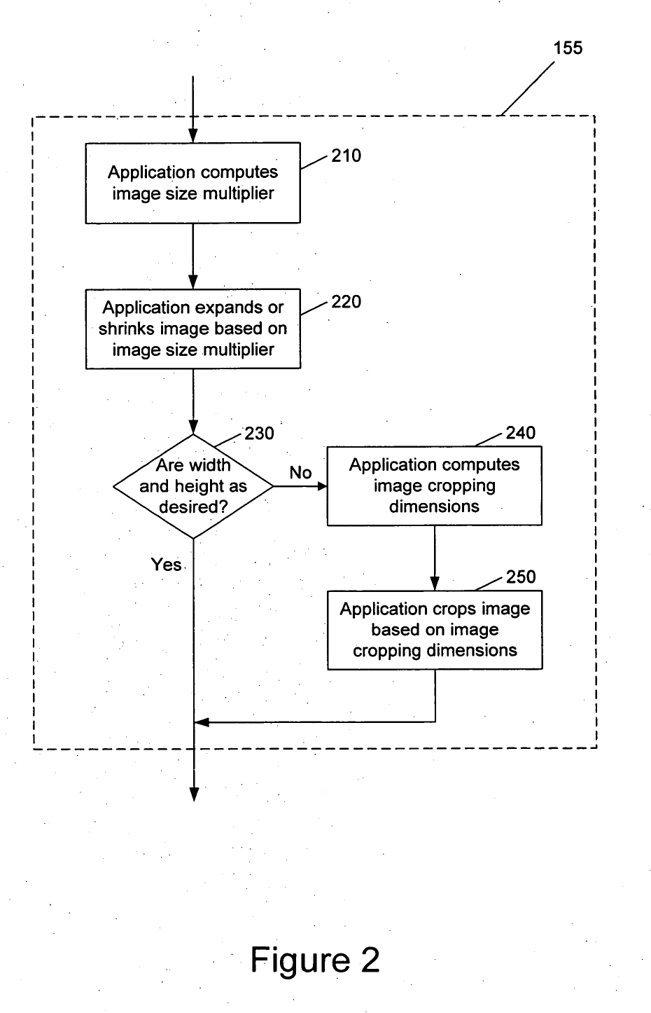

The server application program performs three checks and, as necessary, adjusts the digital image file. These three checks, as shown in FIG. 1 (blocks 150, 160, 170), are shown in a particular order for disclosure of this embodiment only and can easily be switched around or reversed; the order in which these checks are performed is not a critical element of the present invention. First, the server application compares the width and height of the digital image file to the desired target image width and height parameters (block 150). If the digital image file width and height are the desired values, then the server application program continues on to the next check (to block 160). However, if the digital image file width and height are not the desired values, the server application program adjusts the digital image file to bring it into conformance with the desired parameters (block 155). An embodiment of this width/height adjustment according to the present invention (block 155) is described below with reference to FIG. 2. Variations of this adjustment process will be apparent to those skilled in the art upon reading the disclosure, and these are to be included in the spirit of the present invention.

Once the digital image file width and height are as desired, the second check of the server application program compares the digital image file format to the desired target image format (block 160). For this check, by way of example, the server application program can read the image and interpret identifiers found within the digital image file, or the server application program can identify trends in the graphic data, which are unique to a particular format, of the digital image file. If the digital image file format is as desired, the server application program continues on to the final check (to block 170). However, if the digital image file format is not as desired, the server application program converts the digital image file to the desired target image format (block 165).

After ensuring that the digital image file width, height and format are as desired, the server application program performs the third, and final, check. The server application program compares the digital image file resolution to the desired target image resolution to determine whether the digital image file resolution is greater than the desired target image resolution (block 170). This check, for example, is performed by parsing through the contents of the digital image file and reading its embedded information. If the digital image file resolution is as desired, the server application program saves the fully adjusted digital image file for use in the target web site (block 180), as referred to above. However, if the digital image file resolution is not as desired, the server application program converts the digital image file to the desired resolution (block 175). Adjusting the resolution according to the present invention is generally dependent upon the format of the digital image file. Each format type (e.g., JPG or GIF) uses its own graphic compression style. Reducing resolution uses these graphic compression styles, which are, for most formats, available through publicized standards. Thereafter, the server application program saves the fully adjusted digital image file for use in the target web application or site (block 180).

Line 190 indicates the optional storage of the finally adjusted digital image file onto a fixed medium (block 125). The fixed medium can be, for example, any type of non-volatile memory (e.g., hard drive, tape drive, optical drive, etc.). By saving the finally adjusted digital image file in this manner, the server application program can recall the image at a later date/time for re-submission to the web application or site for which the image was originally adjusted, or for a new web application or site that requires similar image parameters as the web application or site for which the image was originally adjusted.

FIG. 2 illustrates an embodiment of the width/height adjustment of the digital image file as previously referred to in FIG. 1, block 155. When the width and height of the digital image file are not as desired, the server application program performs two adjustments, as necessary, to make the digital image file conform to the desired target image parameters, without causing distortion and skewing.

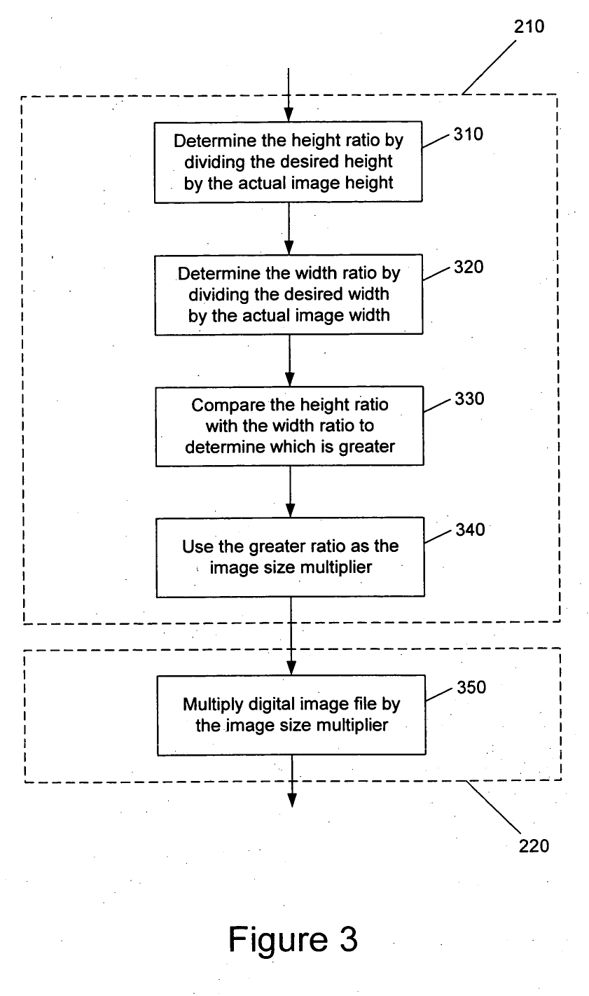

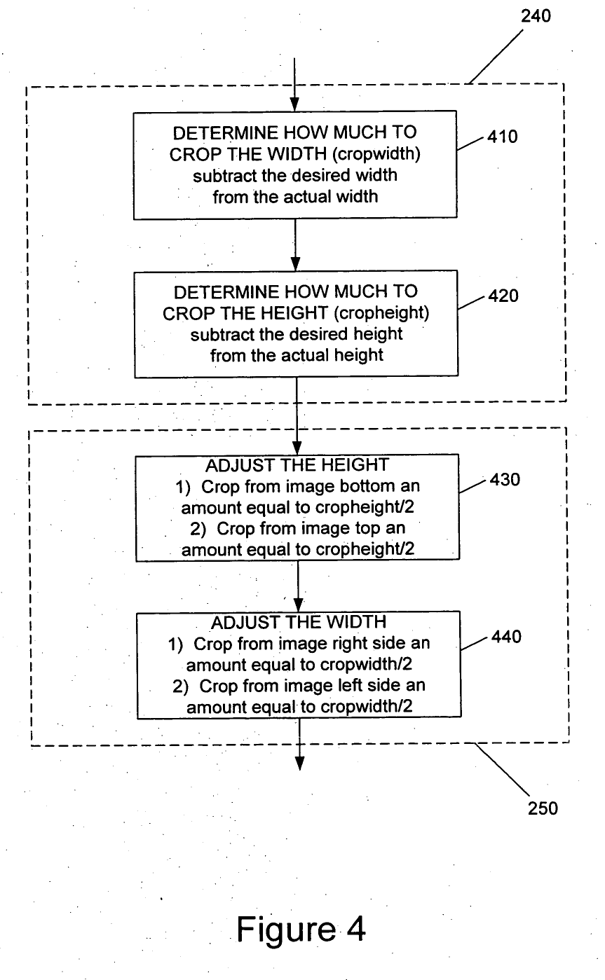

First, the server application program computes an image size multiplier (block 210), and expands or shrinks the digital image file according to the multiplier (block 220). It will be appreciated by those skilled in the art that the process of expanding or shrinking the digital image file may be performed using any suitable scaling technique. Further details of the image size multiplier are present below with reference to FIG. 3. After performing this first adjustment, the server application program then determines whether the adjusted digital image file width and height are now as desired (block 230). If the digital image file width and height are now as desired, then the size and shape adjustment process is complete. However, if the digital width and height are still not as desired, the server application program then performs the second adjustment. The server application program computes image cropping dimensions (block 240), and crops the digital image file to the desired target width and height dimensions (block 250). Further details of the image cropping dimensions are present below with reference to FIG. 4. After performing this second adjustment, the size and shape adjustment process is complete.

As should be evident to those skilled in the art after reviewing the disclosure, above, in relation to FIG. 2, the order of the two adjustments could easily be reversed depending upon the size and shape parameters used by the server application program. For example, the cropping function could be performed first, based on a desired aspect ratio, before the expanding/shrinking function. Such flexibility in the order of performing the size and shape adjustments is intended to be within the scope of the present invention.

FIG. 3 further illustrates an aspect of the present invention that computes the image size multiplier and adjusts the digital image file according to the multiplier, as previously discussed with reference to FIG. 2 (blocks 210, 220). As shown in FIG. 3, the server application program first determines a height ratio (block 310), which, by way of example, is equal to the desired target image height divided by the actual digital image file height. Next, the server application program determines the width ratio (block 320), which, also by way of example, is equal to the desired target image width divided by the actual digital image file width. It will be apparent to those skilled in the art that these ratios could easily be calculated in many different ways, such as inverting the two exemplary formulas. Such alternative calculations are intended to be within the scope of the present invention. The server application program then compares the height ratio to the width ratio to determine which of them is the greater value (block 330) and uses the greater value as the image size multiplier (block 340). These processes 310-340 are effectively the content of block 210 of FIG. 2. The server application program next re-sizes the digital image file by multiplying the digital image file by the image size multiplier (block 350), which is effectively the content of block 220 of FIG. 2.

Exemplary code for performing the image size multiplier process of the present invention is given below.

Sample Code 1:

sub getDestinationMultiplier {
my ($height, $destheight, $width, $destwidth) = @_;

# Variables received by function (Integers)
# $destheight and $destwidth are the desired
# height and width, respectively, $height and
# $width are the actual height and width.

```
    my $heightratio = $destheight / $height;
    my $widthtratio = $destwidth / $width;
    my $multiplier = $heightratio;
```

# The multiplier is either the width ratio or
# the height ratio, whichever value is greater.

```
    $multiplier = $widthtratio if $widthtratio > $heightratio;
    $multiplier *= 100;
    return $multiplier;
}
```

Once the image size multiplier is applied to the digital image file, either the width of the height of the digital image file will likely be at the desired level, but possibly not both. In order to get the digital image file to the precise size and shape dimensions desired without distorting the digital image file, cropping is usually necessary on either the width edges or the height edges. This is accomplished in FIG. 4 at blocks 240 and 250 and further detailed below.

FIG. 4 further illustrates an aspect of the present invention that computes the image cropping dimensions and crops the digital image file according to the cropping dimensions, as previously discussed with reference to FIG. 2 (blocks 240, 250). The image cropping dimensions are how much of the digital image file should be cropped vertically and/or horizontally to reach a desired image size and shape. As shown in FIG. 4, the server application program first determines how much of the digital image file width to crop (block 410) by subtracting the desired target image width from the actual digital image file width (i.e., the cropwidth). Next, the server application program determines how much of the digital image file height to crop (block 420) by subtracting the desired target image height from the actual digital image file height (i.e., the cropheight). The content of blocks 410 and 420 is essentially that of block 240 of FIG. 2. It will be apparent to those skilled in the art that these cropping parameters could easily be calculated in many different ways, such as reversing the subtraction order of the two exemplary formulas. Such alternative calculations are intended to be within the scope of the present invention.

The server application program then crops the digital image file height (block 430) by taking off from each of the bottom and the top of the digital image file an amount equal to ½ of the previously determined cropheight. The server application program also crops the digital image height width (block 440) by taking off from each of the right side and the left an amount equal to ½ of the cropwidth. The content of blocks 430 and 440 is essentially that of block 250 of FIG. 2.

Exemplary code for performing the image cropping process of the present invention is given below.

Sample Code 2:

sub getCropstringParameters {
my ($height, $destheight, $width, $destwidth) = @_;

# Variables received by function (Integers)
# $destheight and $destwidth are the desired
# height and width, respectively, $height and
# $width are the actual height and width.

```
  my $cropwidth = $width − $destwidth;
  my $cropheight = $height − $destheight;
  my $take_off_of_left = $cropwidth / 2;
  my $take_off_of_right = $cropwidth / 2;
  my $take_off_of_bottom = $cropheight / 2;
  my $take_off_of_top = $cropheight / 2;
  return $take_off_of_bottom, $take_off_of_top, $take_off_of_left,
$take_off_of_right;
}
```

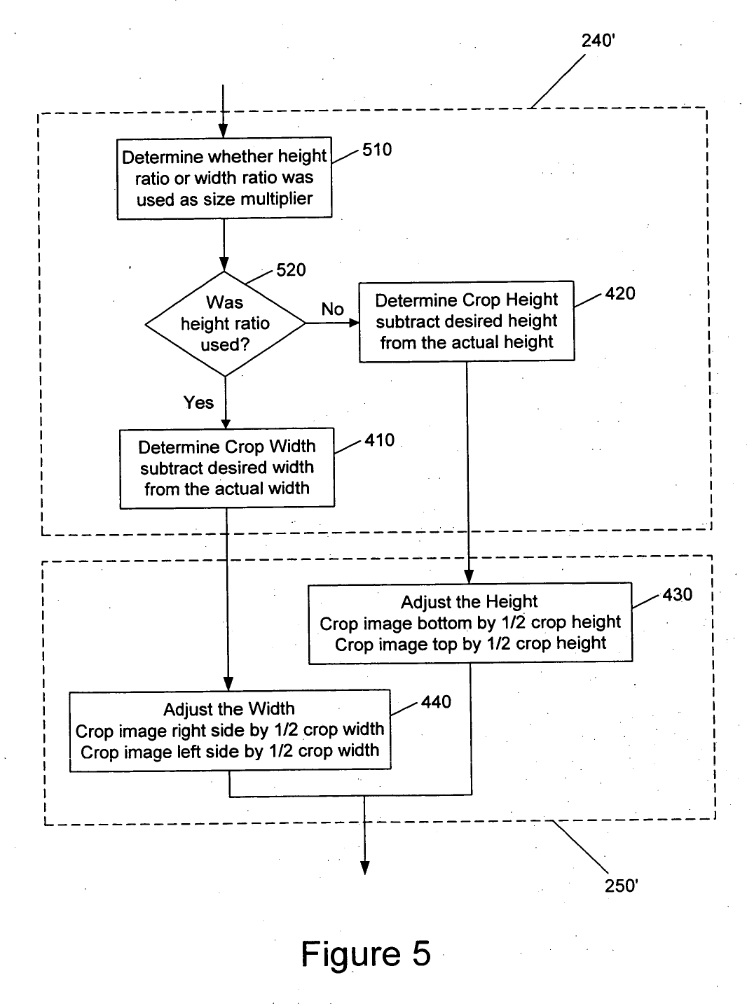

FIG. 5 illustrates an alternate aspect of the present invention that computes the image cropping dimensions and crops the digital image file according to the cropping dimensions, as previously discussed with reference to FIG. 2 (blocks 240, 250). Here, though, the alternate aspect is designated as blocks 240′ and 250′, which blocks perform the same general functions as blocks 240 and 250, respectively. As shown in FIG. 5, the server application program first determines whether, in the size adjustment process previously discussed in relation to FIG. 3, the height ratio or the width ratio was used as the size multiplier (block 510). Then, based on this determination (block 520), the server program either crops the width or height of the digital image file, but not both. This is because, for example, if the height ratio was used as the size multiplier, then the height is the correct size and the width is too large, and only the width needs cropping. Once the determination of which aspect requires cropping is made, the server application program calculate a cropping dimension and crops the digital image file using the formula and process as previously discussed in relation to blocks 410-440 of FIG. 4 (except the cropping is performed in only one aspect). It will be apparent to those skilled in the art that these cropping parameters could easily be calculated in many different ways, such as reversing the subtraction order of the two exemplary formulas. Such alternative calculations are intended to be within the scope of the present invention.

While the present invention has been described herein with reference to particular embodiments thereof, a latitude of modifications, various changes and substitutions are intended in the foregoing disclosure. For example, steps with the disclosed process can be combined or divided and their order changed without deviating from the scope of the present invention. Further, it will be appreciated that in some instances some features of the invention will be employed without a corresponding use of other features without departing from the spirit and scope of the invention as set forth in the appended claims.

1. A method for automatically adjusting height and width of a digital image maintained as an image file to a desired height and width without distortion or skewing comprising the steps of
comparing, in a host computer, the height and width of an image to the desired height and width,
computing an image size multiplier if the height and width do not match the desired height and width, and scaling in a host computer the image in accordance with the image size multiplier,
comparing the scaled image to the desired and width, and
cropping by means of a host computer at least one of a group comprising height and width of the image if the dimensions do not match the desired height and width.

2. The method of claim 1 wherein the computing step includes calculating a height ratio by dividing image height by the desired height.

3. The method of claim 2 wherein the computing step further includes calculating a width ratio by diving the image width by the desired width.

4. The method of claim 3 wherein the computer step further includes comparing the height ratio to the width ratio, and using the larger ratio as the image size multiplier.

3. The method of claim 1 wherein the image is not rectangular in shape.

4. The method of claim 1 wherein the cropping step includes subtracting the desired image width from the scaled image width.

5. The method of claim 4 wherein the cropping step further includes subtracting the desired image height from the scaled image height.

6. The method of claim 1 further including the step of adjusting resolution to cause the file size of the image to approximate a desired file size.

7. The method of claim 6 wherein the file size is reduced to a size less than the desired file size.

8. The method of claim 1 further including the step of converting format to a desired format.

9. A method for automatically conforming a digital image to a set of predetermined parameters provided by a target application, the predetermined parameters including dimensions describing the shape and size of the digital image, a file format and a resolution, the method comprising the steps of
determining initial dimensions of the digital image and, if the initial dimensions do not match the predetermined dimensions, adjusting the size and shape of the digital image to conform the dimensions of the digital image to the predetermined dimensions;
determining the file format of the digital image and, if the file format does not match the predetermined file format, converting the file format of the digital image to the predetermined file format; and
determining the resolution of the digital image and, if the resolution does not match the predetermined resolution, modifying the resolution of the digital image to match the predetermined resolution; and
transferring the conformed image to the target application.

10. The method of claim 9, wherein
the conformed image is two dimensional and rectangular, having a left edge, a right edge, a top edge and a bottom edge, a predetermined height equal to the length of the left and right edges of the conformed image and a predetermined width equal to the length of the top and bottom edges of the conformed image, and
the digital image is rectangular in shape having a left edge, a right edge, a top edge and a bottom edge, an image height equal to the length of the left and right edges of the digital image and an image width equal to the length of the top and bottom edges of the digital image.

11. The method according to claim 10, wherein adjusting the size and shape includes the steps of:
calculating a height ratio by dividing the predetermined height by the image height and a width ratio by dividing the predetermined width by the image width;
selecting an image size multiplier, wherein the image size multiplier is the greater in value of the height ratio and the width ratio;
scaling the digital image in both dimensions using the image size multiplier as a scaling factor to obtain a scaled digital image;
cropping the scaled digital image vertically by deleting from the scaled digital image, if necessary, the area of the scaled digital image above a first horizontal line located at a distance of exactly half the calculated crop height below the top edge of the scaled digital image, and the area of the scaled digital image below a second horizontal line located at a distance of exactly half the calculated crop height above the bottom edge of the scaled digital image; and
cropping the scaled digital image horizontally by deleting from the scaled digital image, if necessary, the area of the scaled digital image to the left of a first vertical line located at a distance exactly half the calculated crop width to the right of the left edge of the scaled digital image, and the area of the scaled digital image to the right of a second vertical line located at a distance exactly half the calculated crop width to the left of the right edge of the scaled digital image.

12. The method of claim 10, wherein adjusting the size and shape includes the steps of:
calculating a crop height by subtracting the image height from the predetermined height;
cropping the digital image vertically by deleting from the digital image, if necessary, the area of the digital image above a first horizontal line located at a distance exactly half the calculated crop height below the top edge of the digital image, and the area of the digital image below a second horizontal line located at a distance exactly half the calculated crop height above the bottom edge of the digital image;
calculating a crop width by subtracting the image width from the predetermined width; and
cropping the digital image horizontally by deleting from the digital image, if necessary the area of the digital image to the left of a first vertical line located at a distance exactly half the calculated crop width to the right of the left edge of the digital image, and the area of the digital image to the right of a second vertical line located at a distance exactly half the calculated crop width to the left of the right edge of the digital image.
